(19) United States
(12) Patent Application Publication
(10) Pub. No.: US 2007/0073645 A1
(43) Pub. Date: Mar. 29, 2007

(54) Apparatus and method for identifying relationship mismatches during profiling of multiple data sources

(75) Inventors: Andrey Belyy, Sunnyvale, CA (US); Wu Cao, Redwood City, CA (US); Kurinchi Kumaran, San Jose, CA (US); Freda Xu, San Francisco, CA (US); Monfor Yee, Fremont, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/413,919

(22) Filed: Apr. 28, 2006

Related U.S. Application Data
(60) Provisional application No. 60/720,130, filed on Sep. 23, 2005.

(51) Int. Cl. G06F 17/30

(52) U.S. Cl. 707/2

(57) ABSTRACT

A computer readable medium includes executable instructions to receive a request to compare a first data set and a second data set. Data from the first data set and the second data set is ordered to comply with specified criteria and thereby form ordered data. The ordered data is joined to produce profile data.

### CROSS REFERENCE TO RELATED APPLICATIONS

This application claims the benefit of U.S. Provisional Application No. 60/720,130, entitled “Apparatus and Method for Determining Relationship Mismatch During Data Profiling Operations”, filed on Sep. 23, 2005, the contents of which are hereby incorporated by reference in their entirety.

### BRIEF DESCRIPTION OF THE INVENTION

This invention relates generally to information processing. More particularly, this invention relates to determining relationship mismatch during data profiling operations.

### BACKGROUND OF THE INVENTION

Database profiling is the process of analyzing a database to determine its structure and internal relationships. Database profiling assesses such issues as the tables used, their keys and number of rows; the columns used and the number of rows with a value; relationships between tables; and columns copied or derived from other columns. Database profiling can also include analyses of tables and columns used by different applications; how tables and columns are populated and changed; and the importance of different tables and columns. Database profiling is useful when planning and managing data conversion and data cleanup projects. In addition, database profiling can be an initial step in defining a data quality domain, which is used in data quality profiling.

In some respects, database profiling is analogous to data processing operations performed on a database. Database profiling operations are also analogous to operations performed during the process of migrating data from a source (e.g., a database) to a target (e.g., another database, a data mart or a data warehouse), which is sometimes referred to as Extract, Transform and Load, or the acronym ETL. Unlike database and ETL operations, database profiling is potentially applied to multiple varied data sources and therefore requires different processing techniques.

Current data profiling systems provide rudimentary forms of data processing and characterization. These tools fail to provide efficient data processing operations. Accordingly, it would be desirable to provide improved data profiling techniques that address data processing and characterization deficiencies associated with prior art approaches.

### SUMMARY OF THE INVENTION

The invention includes a computer readable medium comprising executable instructions to receive a request to compare a first data set and a second data set. Data from the first data set and the second data set is ordered to comply with specified criteria and thereby form ordered data. The ordered data is joined to produce profile data.

The invention supports relationship profiling across various data sources. In particular, the invention allows two disparate data sources to be profiled without initial conversion to a proprietary format.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a first source table processed in accordance with an embodiment of the invention

FIG. 4 illustrates a second source table processed in accordance with an embodiment of the invention.

FIG. 5 illustrates the table of FIG. 3 ordered in accordance with processing associated with an embodiment of the invention.

FIG. 6 illustrates the table of FIG. 4 ordered in accordance with processing associated with an embodiment of the invention.

FIG. 7 illustrates match processing performed in accordance with an embodiment of the invention.

Like reference numerals refer to corresponding parts throughout the several views of the drawings.

### DETAILED DESCRIPTION OF THE INVENTION

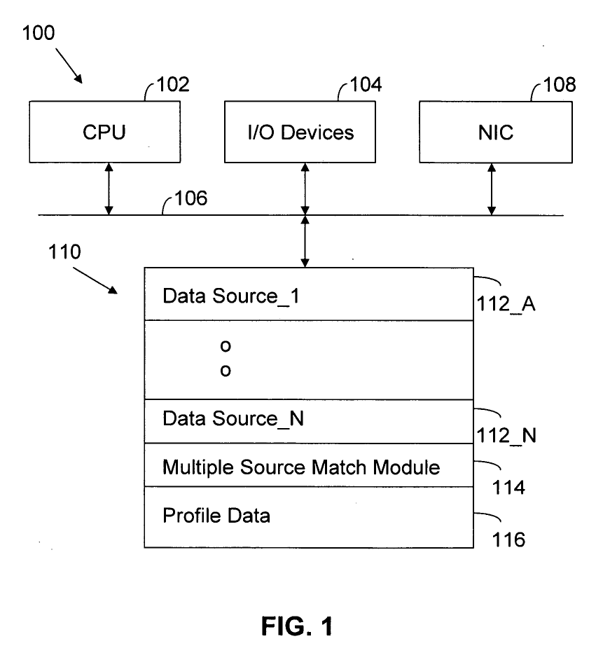

FIG. 1 illustrates a computer 100 configured in accordance with an embodiment of the invention. The computer 100 includes a central processing unit (CPU) 102, which is connected to a set of input/output devices 104 via a bus 106. The input/output devices 104 may include a keyboard, mouse, display, printer, and the like. A network interface circuit 108 is also connected to the bus 106 to provide connectivity to a computer network (not shown). Thus, the invention may operate in a networked environment, such as a client-server environment.

A memory 110 is also connected to the bus 106. The memory 10 may store a set of data sources 112_A through 112_N. For example, the data sources may be selected from database tables, flat files, or various applications, such as an SAP® Application or an Oracle® Application. As discussed below, at any given time, two sources from the set of sources are profiled.

The data sources may also be distributed across a computer network, instead of residing on computer 100. A multiple source match profile module 114 includes executable instructions to implement processing operations associated with the invention. This processing results in profile data 116. It should be noted that the profile data 116 is produced directly from the data sources 112. That is, unlike the prior art, the data from the data sources is not transformed into a common proprietary format prior to generating profile data.

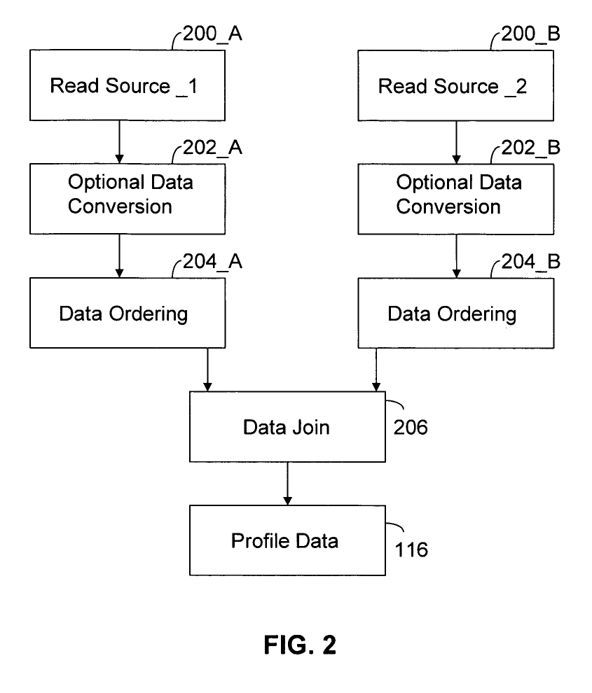

FIG. 2 illustrates processing operations associated with an embodiment of the invention. The processing operations of FIG. 2 may be implemented with executable instructions associated with the multiple source match module 114. Data from a first source is read 200_A and data from a second source is read 200_B. Typically, the first and second data sources are different data sources (e.g., different database vendors), but the different data sources contain common information. For example, the two data sources may have a common key, but different records. The invention operates to profile similarities and differences between these data sources.

An optional data conversion operation 202_A or 202_B may be performed. For example, if the data type from one data source is integer (e.g., department number) and the data type for another data source is char (e.g., department name), the integer values may be converted to char values or vice versa.

Data ordering operations 204_A and 204_B are then performed on the data from the two separate data sources. The data is ordered in accordance with specified criteria, such as numeric ascending order, to produce ordered data. The ordered data includes ordered data from the first source and ordered data from the second source.

The ordered data is then joined 206. In particular, a join operation between the first and second sets of ordered data is performed to produce profile data 116. The profile data may be in any number of forms. For example, the profile data may identify a total number of data mismatches.

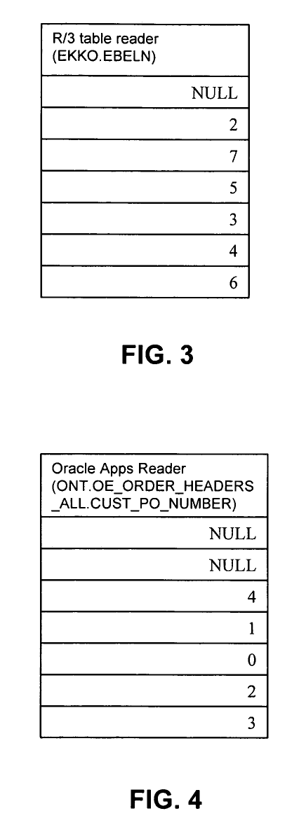

The processing operations associated with the invention are more fully appreciated in connection with an example. In the sales and purchasing modules of an SAP® R/3 source and an Oracle® Applications source, column EBELN of the SAP R/3 source must mach column CUST_PO_NUMBER of the Oracle Application table ONT.OE_ORDER_HEADERS_ALL and vice versa. FIG. 3 illustrates an example of data from an SAP R/3 source table, while FIG. 4 illustrates an example of data from an Oracle Application table.

Because data reside on separate application systems, the primary key/foreign key constraint cannot be enforced at the application or database levels. To insure the data quality of both systems, a customer may want to know: (1) the number of rows in the R/3 table EKKO that do not have a match value for EBELN in the Oracle Application Table ONT.OE_ORDER_HEADERS_ALLCUST_PO_NUMBER column and (2) the number of rows in the Oracle Application table ONT.OE_ORDER_HEADERS_ALL that do not have a match value for CUST_PO_NUMBER in the R/3 table EKKO.

As previously indicated, FIG. 3 illustrates an example of data from an SAP R/3 source table, in particular, column EBELN from the table EKKO. FIG. 4 illustrates an example of data from an Oracle Application table, in particular, the CUST_PO_NUMBER column from the table ONT.OE_ORDER_HEADERS_ALL. The read source operations 200_A and 200_B may be used to produce the information of FIG. 3 and FIG. 4, respectively.

An optional data conversion operation 202 may be performed at this point. For example, if the data type of EKKO.EBELN is integer and the data type of ONT.OE_ORDER_HEADERS_ALL.CUST_PO_NUMBER is char, the EKKO.EBELN information may be converted to char.

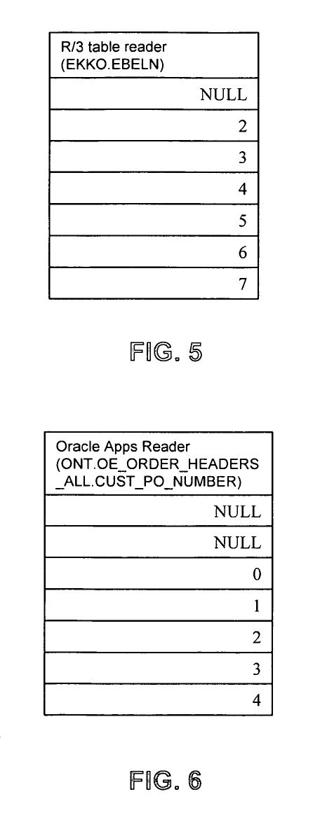

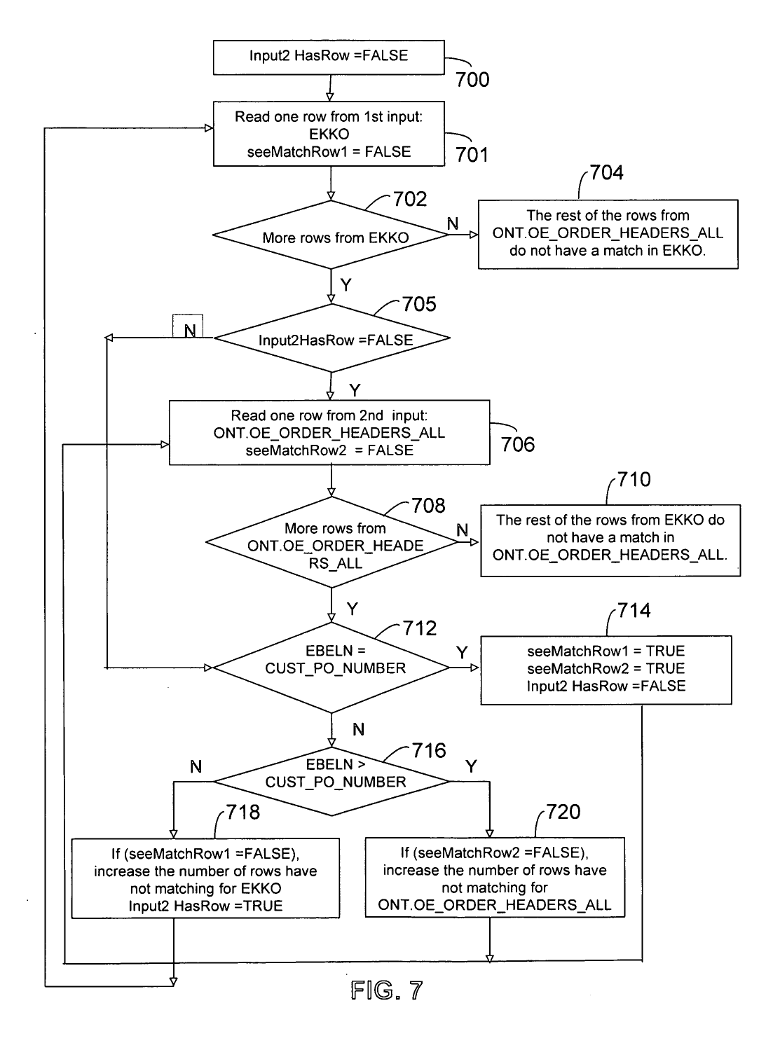

The data ordering operation 204 may now be performed. In this example, the data is ordered in ascending order, resulting in the tables of FIG. 5 and FIG. 6. At this point, the ordered data may be joined 206. In this example, the join operation utilizes a merge sort technique to identify matched and unmatched entries. In this example, NULL is considered equal to NULL. FIG. 7 illustrates processing operations to implement a merge sort operation that will produce profile data in the form of matching and/or non-matching information.

The first operation of FIG. 7 is to set the Boolean variable Input2HasRow to false 700. Next, a row is read from the table of FIG. 5 and a Boolean match variable is set to false 701. It is then determined whether there are more rows in the table of FIG. 5 702. If not, the rest of the rows from the table of FIG. 6 will not match and therefore a mismatch count can be established 704. If there are more rows in the table of FIG. 5, processing proceeds to block 705. If the Input2HasRow variable is set to false, processing proceeds to block 706, otherwise processing proceeds to block 712. In block 706, a row from the table of FIG. 6 is read and a Boolean match variable is set to false. It is then determined whether there are more rows in the table of FIG. 6 708. If not, the rest of the rows in the table of FIG. 5 will not match and a mismatch count can be established 710. If there are more rows to be processed, then processing proceeds to decision block 712, where it is determined whether the values in corresponding rows of FIG. 5 and FIG. 6 match. If there is a match, the Boolean match variables are set to true and the Input2HasRow variable is set to false in block 714. Processing then returns to block 706. By returning to block 706, a value in a subsequent row from the table of FIG. 6 is compared to the same value in the table of FIG. 5.

If there is not a match at block 712, then processing proceeds to block 716. If the value in the table of FIG. 5 is not larger than the corresponding value in the table of FIG. 6, then processing proceeds to block 718, where the tally of mismatched rows is incremented. Processing then returns to block 701.

If the value in the table of FIG. 5 is larger, then processing proceeds to block 720, where the tally of mismatched rows in incremented. Processing then returns to block 706. Thus, another row from the table of FIG. 6 is read and processing proceeds.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium, comprising executable instructions to:
receive a request to compare a first data set and a second data set;
order data from the first data set and the second data set to comply with specified criteria and thereby form ordered data; and
join the ordered data to produce profile data.

2. The computer readable medium of claim 1 further comprising executable instructions to assess whether the first data set and the second data set are compatible.

3. The computer readable medium of claim 2 further comprising executable instructions to convert the first data set and the second data set to the same type of data if the first data set and the second data set are compatible, but not of the same type.

4. The computer readable medium of claim 1 further comprising executable instructions to process the first data set from a first data source and the second data set from a second data source.
